(19) United States
(12) Patent Application Publication
(10) Pub. No.: US 2017/0139077 A1
(43) Pub. Date: May 18, 2017

(54) Optimization of Downhole Logging Tool Data Resolution

(71) Applicant: Halliburton Energy Services, inc, Houston, TX (US)

(72) Inventors: Jason D. Dykstra, Spring, TX (US); Yiming Zhao, Katy, TX (US); Xingyong Song, Houston, TX (US)

(21) Appl. No.: 15/106,941

(22) PCT Filed: Mar. 17, 2015
(86) PCT No.: PCT/US2015/021044

§ 371 Date: Jun. 21, 2016

(51) Int. Cl. G01V 11/00; G06Q 50/02; E21B 47/09; G06Q 10/06; E21B 49/00; E21B 47/024

(52) U.S. Cl. CPC G01V 11/002; E21B 49/00; E21B 47/024; E21B 47/09; G06Q 10/06313; G06Q 10/06315; G06Q 50/02; E21B 47/18

(57) ABSTRACT

Methods and related systems which coordinate the motion of a logging tool string and the operation of individual logging tools along the string to improve the quality of the logging data for producing more accurate models of the downhole environment, for improving the logging operation efficiency, and for providing the capability to avoid violation of logging related constraints.

### FIELD OF THE DISCLOSURE

The present disclosure generally relates to downhole logging and, more particularly, to a method for optimizing the efficiency of a logging tool using the tool speed and data acquisition frequency.

### BACKGROUND

Modern oil field operations demand a great quantity of data relating to the parameters and conditions encountered downhole. Such data typically includes characteristics of the earth formations traversed by the borehole, and data relating to the size and configuration of the borehole itself. The collection of information relating to conditions downhole, which commonly is referred to as “logging,” can be performed by several methods including wireline logging, “logging while drilling” (“LWD”), drillpipe conveyed logging, and coil tubing conveyed logging. This data is useful for reservoir modeling and also for deciding where to drill new wells. The data can also be used for reservoir management decisions, including enhanced production and shutdown, and design strategies to optimize oil recovery. The quality of the data gathered by a logging tool, which is determined by the design and the operation of the tool and ambient noise, affects the quality of the generated reservoir model and the correctness of the reservoir management decisions. Therefore, it is desirous to improve the quality of the data gathered by logging tools.

### BRIEF DESCRIPTION OF THE DRAWINGS

FIG. 1 shows an illustrative LWD environment in which a method of the present disclosure may be utilized;

FIG. 2 shows an illustrative wireline environment in which a method of the present disclosure may be utilized;

FIG. 3 is a spatial profile used to illustrate a case when high resolution of the recorded data is important for accurately characterizing the formation, wherein high resolution can be achieved either by changing the tool speed or the logging data acquisition frequency;

FIG. 4 is a spatial profile used to illustrate how a higher data resolution is not always necessary;

FIG. 5 is a flow chart of a generalized method for optimizing a downhole logging operation, according to certain illustrative methods of the present disclosure;

FIGS. 6A and 6B are spatial profiles showing two cases where the logging data spatial resolution for the variable of interest is sufficiently high, and where the logging data spatial resolution may not be high enough;

FIG. 7 illustrates an illustrative method for determining and maintaining the desired resolution in the method of FIG. 5;

FIG. 8 demonstrates a particular implementation of an illustrative method of the present disclosure which plans the speed profile to achieve better resolution of logging data when the formation property changes fast; and

FIG. 9 is a control block diagram of an illustrative system implementing the method illustrated in FIG. 8.

### DESCRIPTION OF ILLUSTRATIVE EMBODIMENTS

Illustrative embodiments and related methods of the present disclosure are described below as they might be employed in methods for optimizing the operation of a logging tool using the tool speed and data acquisition frequency. In the interest of clarity, not all features of an actual implementation or methodology are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the disclosure will become apparent from consideration of the following description and drawings.

As described herein, embodiments and related methods of the present disclosure are directed to various methods which utilize historical and real-time logging data to optimize the operation of a downhole logging tool. In a generalized method, a logging tool is deployed into a wellbore and logging data is acquired. Using the acquired logging data, a desired logging data resolution of the logging tool is determined. Thereafter, logging tool constraints/operation necessary to achieve the resolution are determined. Such constraints may include, for example, the speed or data acquisition frequency of the logging tool as it moves along the wellbore. Based upon the constraints, control commands are generated and the logging tool is operated accordingly. Therefore, methods described herein coordinate the motion of the logging tool string and the operation of individual logging tools along the string to improve the quality of the logging data for producing more accurate models of the downhole environment, for improving the logging operation efficiency, and for providing the capability to avoid violation of logging related constraints.

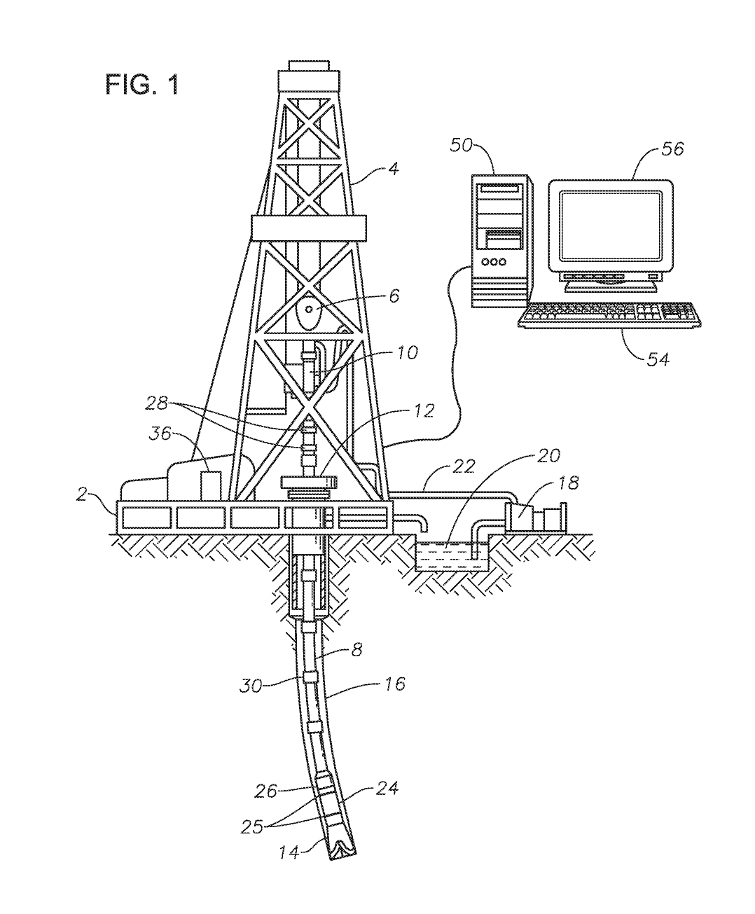

As previously mentioned, methods of the present disclosure may be utilized in a variety of logging applications, including wireline tools being dragged by a tractor or a slick line assembly, for example. Nevertheless, FIG. 1 shows a logging-while-drilling (“LWD”) application utilized in an illustrative method of the present disclosure. A drilling platform 2 supports a derrick 4 having a traveling block 6 for raising and lowering a drill string 8. A top drive 10 supports and rotates drill string 8 as it is lowered through wellhead 12. A drill bit 14 is driven by a downhole motor and/or rotation of drill string 8. As bit 14 rotates, it creates a borehole 16 that passes through various formations. A pump 18 circulates drilling fluid 20 through a feed pipe 22, through the interior of drill string 8 to drill bit 14. The fluid exits through orifices in drill bit 14 and flows upward through the annulus around drill string 8 to transport drill cuttings to the surface, where the fluid is filtered and recirculated.

Drill bit 14 is just one piece of a bottom-hole assembly that includes one or more drill collars (thick-walled steel pipe) to provide weight and rigidity to aid the drilling process. Some of these drill collars include built-in logging instruments to gather measurements of various drilling parameters such as position, orientation, weight-on-bit, borehole diameter, etc. The tool orientation or position may be specified in terms of a tool face angle (rotational orientation), an inclination angle (the slope), and compass direction, each of which can be derived from measurements by magnetometers, inclinometers, and/or accelerometers, though other sensor types such as gyroscopes may alternatively be used. In addition, the tool includes may include sensors, such as, for example, acceleration, speed and position sensors 25. As is known in the art, the combination of those two sensor systems enables the measurement of the tool face angle, inclination angle, and compass direction. Such orientation measurements can be combined with gyroscopic or inertial measurements to accurately track tool position.

A logging tool 24 is integrated into the bottom-hole assembly near bit 14. Although not shown, in other embodiments two or more logging tool may also be utilized. In this illustrative embodiment, logging tool 24 may be, for example, a LOGIQ® High Frequency Dielectric Tool, commercially available through Halliburton Energy Services, Inc. of Houston, Tex. As bit 14 extends the borehole through the formations, logging tool 24 rotates and collects azimuthally-dependent reflection measurements that a downhole controller associates with tool position and orientation measurements. The measurements can be stored in internal memory and/or communicated to the surface. A telemetry sub 26 may be included in the bottom-hole assembly to maintain a communications link with the surface. Mud pulse telemetry is one common telemetry technique for transferring tool measurements to surface receivers and receiving commands from the surface, but other telemetry techniques can also be used.

At the surface, a data acquisition module 36 receives the uplink signal from the telemetry sub 26. Module 36 optionally provides some preliminary processing and digitizes the signal. A data processing system 50 (shown in FIG. 1 as a computer), also referred to herein as a Logging Operation Controller, receives a digital telemetry signal, demodulates the signal, and displays the tool data or well logs to a user. In addition, software present in Logging Operation Controller 50 governs the operation of the downhole assembly, as will be described below. A user interacts with Logging Operation Controller 50 and its software via one or more input devices 54 and one or more output devices 56.

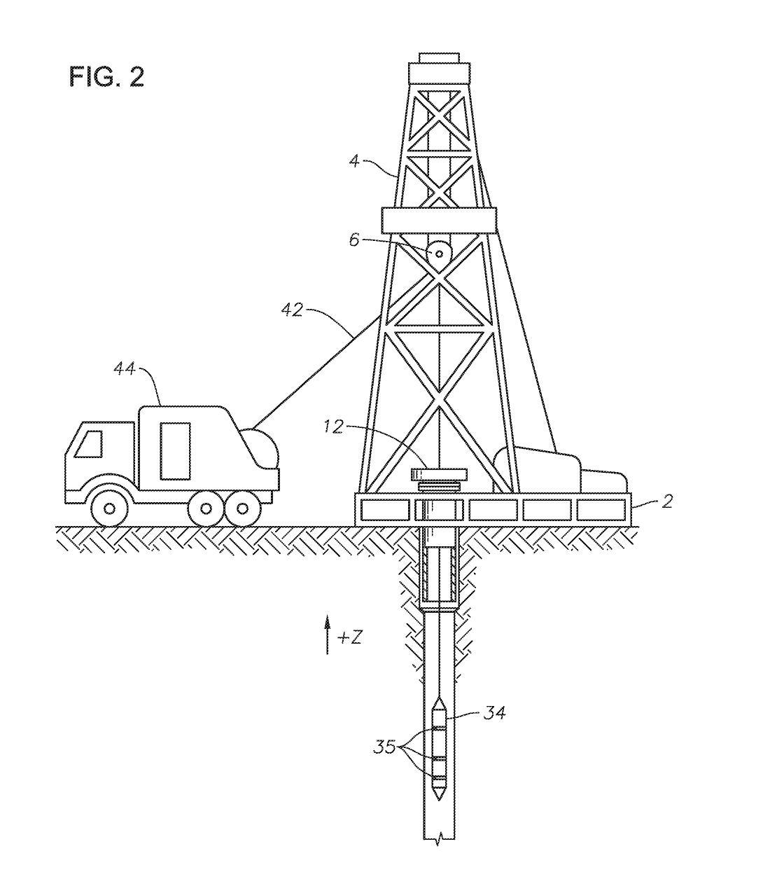

At various times during the drilling process, drill string 8 may be removed from the borehole as indicated in FIG. 2, which shows an embodiment of the present disclosure deployed in a wireline application. In such an embodiment, once drill string 8 has been removed, logging operations can be conducted using a wireline logging tool 34, i.e., a sensing instrument sonde suspended by a cable 42 having conductors for transporting power to the tool and telemetry from the tool to the surface. Logging tool 34 may have any number of sensing pads (not shown), having one or more electromagnetic sensors positioned thereon, that slide along the borehole wall as the tool is pulled uphole. Any variety of other logging sensors may also be utilized. Logging tool 34 also includes various sensors 35 for measuring the motion (e.g., acceleration, speed, position, etc.) of logging tool 34. As previously described in reference to FIG. 1, Logging Operation Controller 44 governs the operation of the wireline assembly as will be described below, collects measurements from logging tool 34, and includes computing facilities for processing and storing the measurements gathered by logging tool 34.

Now that illustrative logging applications have been described, a detailed description of the methods of the present disclosure will now be provided. With generalized reference to FIGS. 1 and 2, during the logging process, logging tool 24, 34 is disposed in a wellbore. The tool string comprises one or more logging tools 24, 34 and, in certain illustrative embodiments, perforating tools. The tool string is suspended in the wellbore and moves downhole either by releasing or retracting the string using an apparatus on the surface, or being pulled or pushed by powered downhole tools or fluid. When the tool string moves in the wellbore, logging tool(s) 24, 34 gather certain logging data of the formation and the downhole condition. This logging data is stored onboard and/or sent back to the surface to Logging Operation Controller 50, 44.

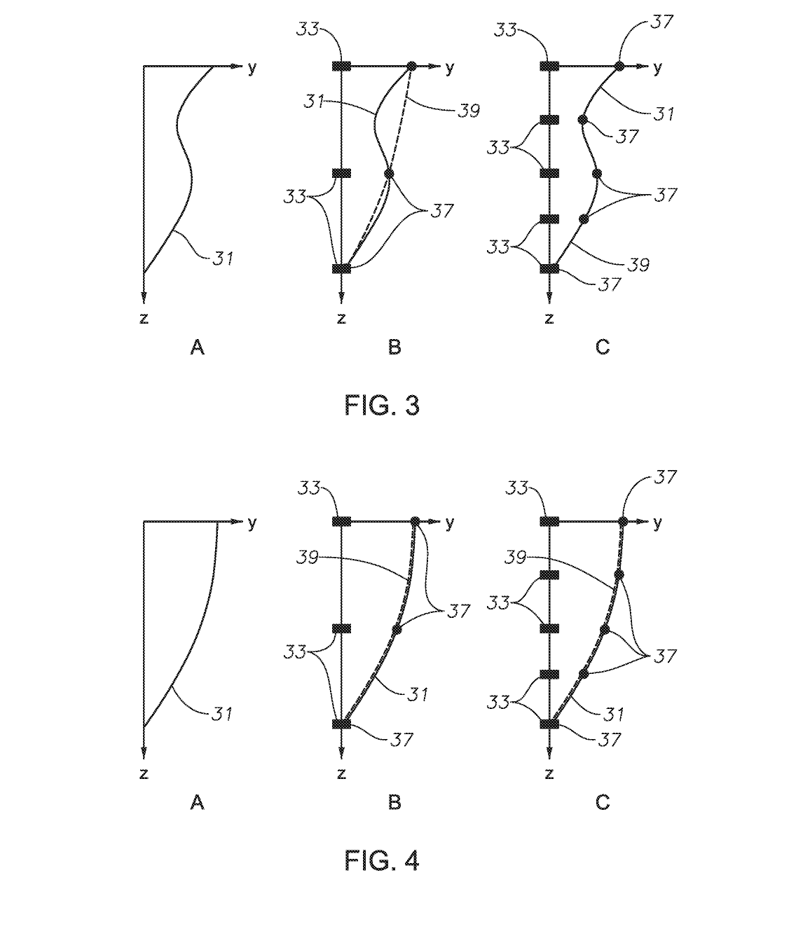

As logging tool(s) 24, 34 are deployed along the formation, the motion of the tool string is measured by sensors 25, 35 to produce motion data. The motion data may be, for example, the speed, acceleration or position of logging tool(s) 24, 34. The motion data of the tool string is sent to Logging Operation Controller 50, 44 in real-time. Logging Operation Controller 50, 44 controls the release or traction of the tool string and the operation of logging tool(s) 24, 34. As will be described in more detail below, there exist two factors which affect the logging data quality: the speed that the tool string moves in the borehole and the frequency that logging tool(s) 24, 34 record the data (i.e., data acquisition frequency). These two factors have similar effects on the resolution of the recorded data, as shown in FIG. 3.

FIG. 3 is a spatial profile used to illustrate a case when high resolution of the recorded data is important for accurately characterizing the formation, wherein high resolution can be achieved either by changing the tool speed or the logging data acquisition frequency. In this example, one variable of interest is considered, which is to be recorded by a logging tool. The z-axis corresponds to the position of the tool in the borehole, while the y-axis shows the magnitude of this variable of interest. This variable may relate to certain conditions downhole or the characteristic of the formation at the corresponding z position. The true value of this variable at different z positions is shown as curve 31 in plots A, B and C.

It is noted that this variable of interest cannot be measured continuously by certain logging tools, such as, for example, an acoustic logging tool. Instead, the logging tool can only be operated at a specified baseline frequency (i.e., data acquisition frequency), which means that this variable of interest is sampled discretely when the tool string moves in the borehole. Rectangles 33 indicate the positions at which such a variable is recorded by the logging tool, and the discs 37 are the corresponding values recorded by the logging tool. The dotted lines 39 are the spatial profile of the variable of interest based on the logging data. A smaller discrepancy between curve 31 and dotted lines 39 indicates a higher quality of logging data.

With reference to FIG. 3, consider two scenarios in this example. In the first scenario, which is shown in plot B, the tool string moves at a baseline speed, and the logging tool operates at a baseline logging data acquisition frequency. In the second scenario, plot C, the logging tool operates at the same baseline data acquisition frequency. However, the speed of the tool string is only 50% of the baseline speed as in the first scenario (plot B). As compared to the first scenario, the spacing between the locations where logging data is obtained (rectangles 33) is shorter in the second scenario, and more sets of logging data are obtained over the same distance along the borehole. Therefore, the resolution of the logged data in the second scenario (plot C) is higher than the resolution of the data in plot B, i.e., smaller spacing between neighboring positions of data acquisitions means a higher resolution.

When reconstructing the spatial profile of the variable of interest along the borehole using the logging data, a better reconstruction can be obtained in plot C wherein the logging data is denser in space than in plot B, i.e., there is a match or close similarity between curve 31 and dotted line 39. Therefore, slowing down the tool string speed can help improve the quality of the logging data. However, on the downside, slowing down the tool string speed will reduce the efficiency of the logging process.

Similarly, increasing the data acquisition frequency of the logging tool can achieve a similar effect as slowing down the tool string speed. However, such a frequency is limited by the design of the tool as well as the downhole condition, and cannot be increased arbitrarily.

Although high data resolution will assist in reconstructing the variable of interest more accurately, as show in FIG. 3, it is not always necessary, since sometimes the accuracy improvement could be trivial or undesirable. FIG. 4 illustrates this principle using plots A, B and C, wherein high resolution of logging data is unnecessary. Specifically, although the logged data in plot C of FIG. 4 has a higher spatial resolution, the reconstructed variable of interest spatial profile (represented by dotted lines 39 is not significantly more accurate than the spatial profile 39 of plot B, because the true variable of interest does not change rapidly along the z-axis.

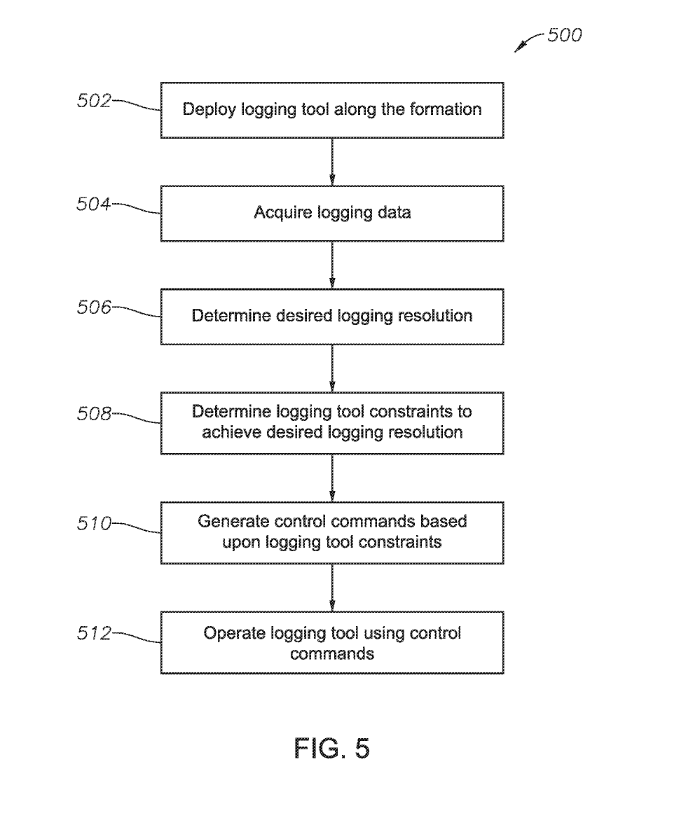

Based upon the foregoing, FIG. 5 is a flow chart of a generalized method for optimizing a downhole logging operation, according to certain illustrative methods of the present disclosure. As previously described, Logging Operation Controller 50, 44 controls the logging operation. Therefore, at block 502, one or more logging tools are deployed downhole using any desired application (wireline, drill string, etc.). As Logging Operation Controller 50, 44 moves the logging tool(s) along the wellbore and through the formation, logging data is recorded and processed at block 504, in addition to reference logging data is also process. The logging data may be, for example, real-time logging data relating to formation resistance, slowness, etc. The reference logging data may be, for example, historical logging data of the wellbore or logging data of an adjacent wellbore retrieved from a local or remote database.

At block 506, Logging Operation Controller 50, 44 determines the desired logging resolution for the logging tool(s) based upon the acquired logging data. In certain methods, the desired logging resolution is determined using the historical logging data. In other methods, the desired logging resolution is determined using data from adjacent wellbores. In yet other methods, the desired logging resolution is determined using the real-time logging data of the wellbore in which the logging tool(s) are deployed.

At block 508, Logging Operation Controller 50, 44 determines the operational constraints necessary for the logging tool(s) to achieve the desired logging resolution. In certain methods, the constraints comprise motion constraints of the logging tool(s) (which includes the speed of the logging tool(s) and total logging operation time. In other methods, the constraints are data acquisition frequencies for the logging tool(s). In yet other methods, Logging Operation Controller 50, 44 controls the motion of the tool string and operation of individual logging tools by solving an optimization problem that minimizes a cost function subject to the operational constraints. As will be described in more detail below, here Logging Operation Controller 50, 44 compares the speed and data acquisition frequency constraints using the cost function, and selects the constraints based upon this comparison.

Additionally, at block 508, Logging Operation Controller 50, 44 coordinates and optimizing the tool string motion and the operation frequency of the one or more logging tools subject to the determined constraints. At block 510, Logging Operation Controller 50, 44 generates control commands for motion control and tool operation based upon the determined constraints. Thereafter, at block 512, the one or more logging tool(s) disposed along the wellbore are operated according to the control commands.

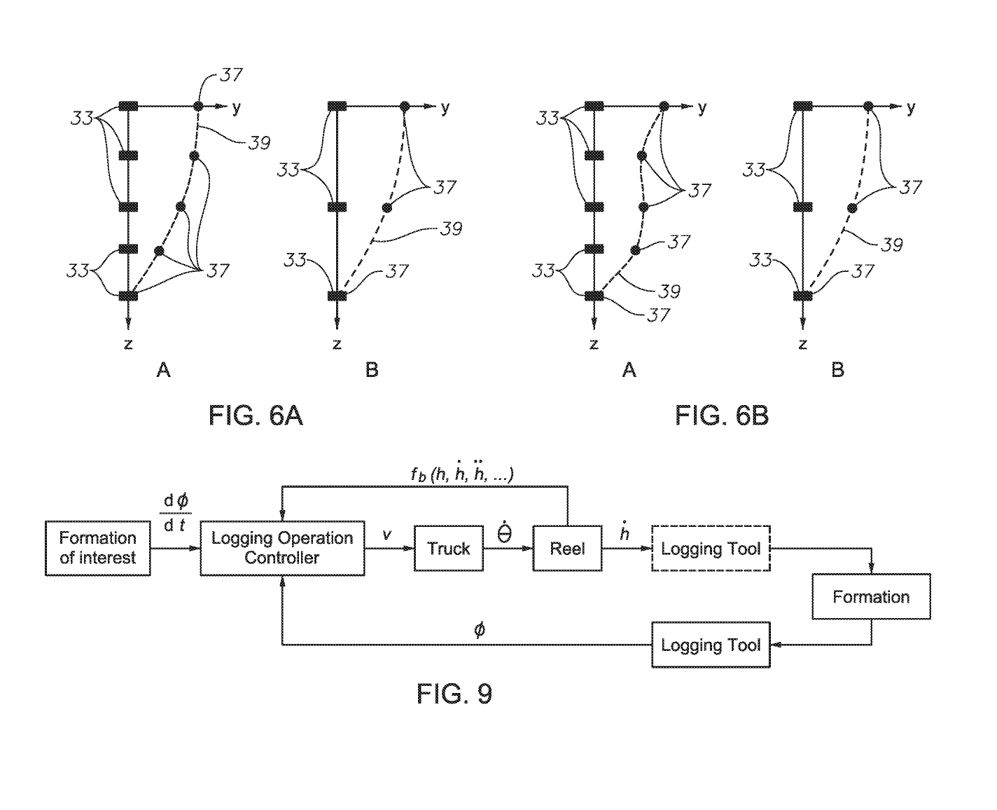

Now that a generalized method has been provided, a more detailed description of the specific process will now be described. With reference to block 506, certain methods of the present disclosure utilize a down sampling method in which to determine the desired data resolution. To illustrate this feature, FIGS. 6A and 6B are spatial profiles showing two cases, wherein the logging data spatial resolution for the variable of interest is sufficiently high, and could possibly be reduced in the first case shown in FIG. 6A, while the logging data spatial resolution in the second case as shown in FIG. 6B may not be high enough, and should either be maintained or increased.

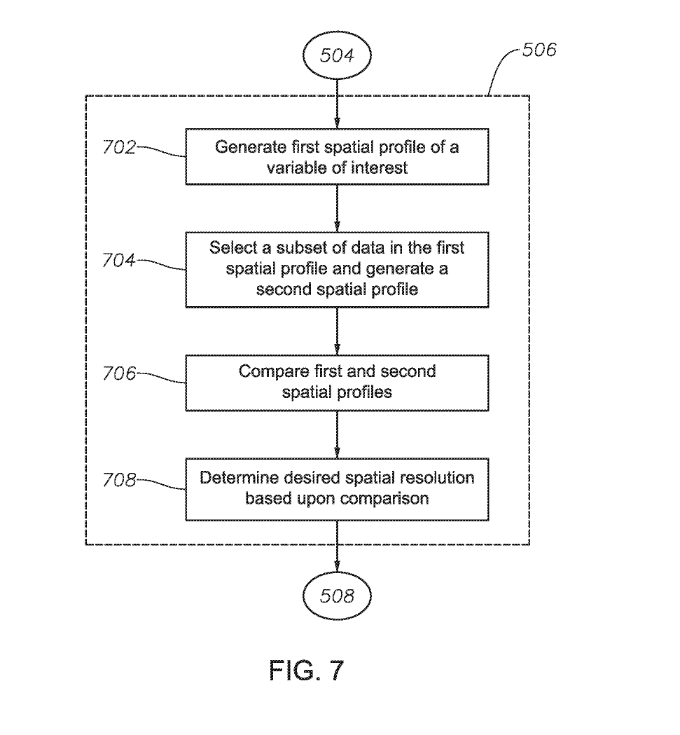

FIG. 7 illustrates an illustrative method for determining and maintaining the desired resolution at block 506. At block 702, Logging Operation Controller 50, 44 generates a reconstructed spatial profile of the variable of interest over a certain distance along the z-direction near the current position of the logging tool. In this example, the original profile may have been generated based upon logging data or estimations using other data sources. Nevertheless, the spatial profile includes data related to the position of the logging tool along the z-direction with respect to the magnitude of the variable of interest, as illustrated in other spatial profiles described herein. At block 704, Logging Operation Controller 50, 44 selects a sub-set of the logged data over the same distance, and reconstructs a second spatial profile for the variable of interest using the sub-set of logged data. The second spatial profile is essentially a down sampling of the logging data.

At block 706, Logging Operation Controller 50, 44 compares the first and second spatial profiles. If the difference is sufficiently small, then the current logging resolution is sufficiently high, and Logging Operation Controller 50, 44 computes a lower desired resolution based on the difference at block 708. This lower resolution is then used in subsequent logging operations until the difference between the two profiles lies in a certain threshold range. If the difference falls outside a certain range, then a higher desired resolution is determined by Logging Operation Controller 50, 44 and used in subsequent logging operation until the difference lies in a certain range, which may be determined based upon, for example, historical data.

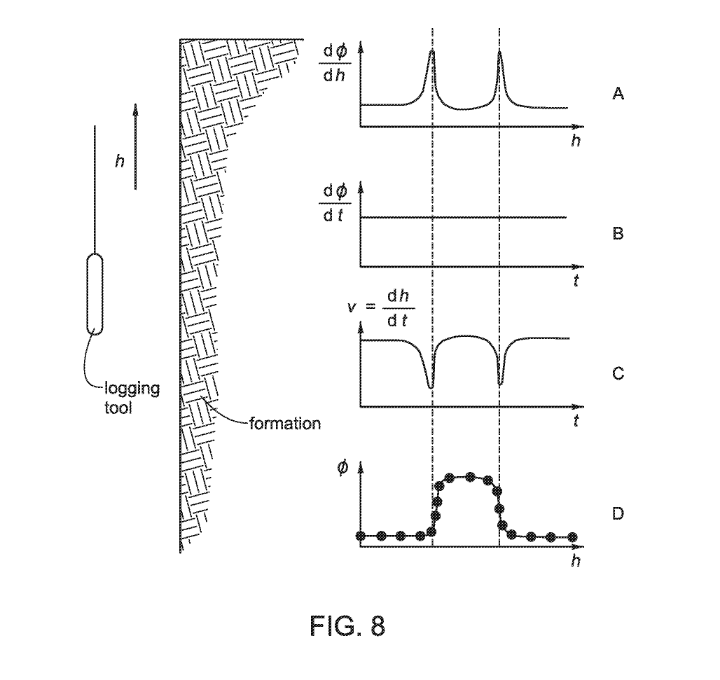

FIG. 8 shows one example, demonstrating a particular implementation of an illustrative method of the present disclosure, which plans the speed profile to achieve better resolution of logging data when the formation property changes fast. Let φ be the variable of interest in the logging process. When the tool moves in the borehole, the measured variable, φ, changes along the length h of the borehole, and the rate of change with respect to h is calculated. In this example, the profile of (dφ)/(dh) is shown in plot 8A. Note that the (dφ)/(dh) profile may be the rate of change along the formation of a single data point or multiple data points which correspond to a variable of interest. For example there are multiple streams of logging data recorded, including φ₁, φ₂, . . . , but the variable φ of interest is a function of these data, φ=f(φ₁, φ₂, . . . ). Nevertheless, when the (dφ)/(dh) value is large, the formation is changing at the corresponding location, and it is desired to gather more logging data to better capture where and how exactly the formation changes.

Next, choose a desired rate of change of φ with respect to time, t, i.e., (dφ)/(dt). Typically, it is sufficient to set the desired (dφ)/(dt) at a constant value, as shown in plot 8B. Based on these two rate of changes, (dφ)/(dh) and (dφ)/(dt), the speed, v, of the logging tool can be planned using:

v=(dh)/(dt)=((dφ)/(dt))/((dφ)/(dh)) Eq. (1)

The planned speed profile for this example is illustrated in plot 8C, and the corresponding resolution of φ can be seen from plot 8D. Thus, using this method, more logging data is gathered around places where the formation changes faster along the borehole direction, thus providing better resolution. As shown in FIG. 8, the logging tool slows down where the rate of change (dφ)/(dh) is large, such that more logging data is gathered to achieve better resolution.

FIG. 9 is a control block diagram of a system implementing the method illustrated in FIG. 8. In this illustrative system, a truck having a reel thereon is used to deploy the logging tool along a wireline. A (dφ)/(dt) profile is planned before the logging operation begins using historical logging data or data estimated from neighboring wellbores. In this example, the Logging Operation Controller sends control commands v to the logging truck to control the rotation speed θ the reel, and retracting or releasing the logging tool at a certain speed h. In other methods, however, the control command may be, for example, current or voltage to the motor. Nevertheless, the reel returns various motion related measurements, f_{b}(h, . . . ), to the Logging Operation Controller for feedback control. The logging tool returns the logged data φ to the Logging Operation Controller, which calculates (dφ)/(dh) first, then computes the desired speed command to maintain the appropriate logging data resolution. The motion of the logging tool (e.g., tool speed) is also sent back to the controller (from downhole sensors) to form a feedback loop in order to regulate the reel rotation and track the desired speed of the logging tool.

In certain illustrative methods, a cost function is utilized to determine the logging tool constraints/operation. Here, the pre-job planning of (dφ)/(dt) using historical data of offset wells can be achieved by minimizing a cost function which mainly penalizes the deviation of the actual resolution from the desired resolution. Other penalty terms can also be added to the cost function to balance different desired performances. Constraints such as tool speed constraint, wireline tension force constraint and time constraint can also be considered during the optimization. For example, the tool speed may be regulated because of the physical limits on the motion of the wireline tool truck. Furthermore, the time limit of the logging operation may also be addressed. The following cost function is an example, by the minimization of which a speed profile and a resolution level can be obtained based on historical logging data.

$${min}_{R , v} {\int }_{0}^{{h}_{f}} [ {( v ( h ) \frac{d {φ}_{H}}{d h} - R )}^{2} + g ( v ) + f ( R ) ] d h , \qquad Eq . ( 2 )$$

Where φ_{H} is the logging data from nearby offset wells, v is the speed profile to be planned, and R is the desired resolution to be maintained during the logging process. g(v) is a penalty term which helps regulate the speed profile. f(R) is a penalty term regulating the achieved resolution to an appropriate level.

There are a variety of modifications which may be made to the methods described herein. For example, in certain methods, different weights are assigned to the desired logging resolutions corresponding to individual logging tools on the tool string in order to determine the motion of the whole tool string. In other methods, the logging data is communicated to the Logging Operation Controller in real-time. In yet other methods, estimated or historical data about the downhole condition of the wellbore is passed to the Logging Operation Controller.

In certain other methods, the tool string also includes at least one sensor measuring the tension of the cable connecting the tools to the wireline logging truck. The measurement of this sensor is sent to the Logging Operation Controller. The logging operation controller then regulates the acceleration of the tool string based on the sensor measurement such that the strain on the tool string is within a safe range to ensure that the string does not break. In this way, the logging operation efficiency can be improved by hanging more and heavier wireline tools on the tool string.

In yet other methods of the present disclosure, the tool string is allowed to move in both directions repeatedly to perform logging in order to achieve higher resolution of the same region of interest in the borehole. In other methods, the tool string is allowed to move back and perform logging over the same region of interest in order to reduce the adverse influence of measurement noise.

Embodiments and methods described herein further relate to any one or more of the following paragraphs:
1. A method for optimizing a downhole logging operation, comprising deploying a logging tool into a wellbore extending along a formation; acquiring logging data of the formation; determining a desired logging resolution for the logging tool based upon the acquired logging data; determining logging tool constraints necessary to achieve the desired logging resolution; generating control commands for the logging tool based upon the logging tool constraints; and operating the logging tool in accordance to the control commands.
2. A method as defined in paragraph 1, wherein determining the logging tool constraints comprises determining speed constraints of the logging tool.
3. A method as defined in paragraphs 1 or 2, wherein determining the logging tool constraints comprises determining data acquisition frequency constraints of the logging tool.
4. A method as defined in any of paragraphs 1-3, wherein determining the logging tool constraints comprises determining speed constraints of the logging tool; determining data acquisition frequency constraints of the logging tool; and comparing the speed and data acquisition frequency constraints using a cost function, wherein the logging tool constraints are selected based upon the comparison.
5. A method as defined in any of paragraphs 1-4, wherein acquiring the logging data of the formation comprises acquiring historical logging data of the wellbore.
6. A method as defined in any of paragraphs 1-5, wherein acquiring the logging data of the formation comprises acquiring logging data of an adjacent wellbore.
7. A method as defined in any of paragraphs 1-6, wherein acquiring the logging data of the formation comprises acquiring real-time logging data of the wellbore.
8. A method as defined in any of paragraphs 1-7, wherein the logging data comprises acquiring motion data of the logging tool.
9. A method as defined in any of paragraphs 1-8, wherein determining the desired logging resolution comprises generating a first spatial profile of a variable of interest along a distance of the wellbore near a current position of the logging tool, the first spatial profile comprising data related to a position of the logging tool with respect to a magnitude of the variable of interest; selecting a subset of the data over the distance of the wellbore; generating a second spatial profile for the variable of interest using the subset of data; comparing the first and second spatial profiles; and determining the desired logging tool resolution based upon the comparison.
10. A method as defined in any of paragraphs 1-9, wherein the variable of interest is represented by a single data point or a plurality of data points.
11. A method as defined in any of paragraphs 1-10, wherein determining the logging tool constraints comprises minimizing a cost function subject to the logging tool constraints.
12. A method as defined in any of paragraphs 1-11, wherein the cost function penalizes a deviation of an actual logging resolution from the desired logging resolution.
13. A method as defined in any of paragraphs 1-12, wherein the cost function considers logging tool constraints comprising at least one of a logging tool speed, wireline tension force or operation time.
14. A method as defined in any of paragraphs 1-13, wherein the logging tool is deployed as part of a wireline, drilling or slick line assembly.
15. A method for optimizing a downhole logging operation, the method comprising deploying a logging tool into a wellbore extending along a formation; acquiring logging data of the formation; and adjusting in real-time at least one of a speed or data acquisition frequency of the logging tool based upon the acquired logging data.
16. A method as defined in paragraph 15, further comprising utilizing a cost function to determine whether to adjust the speed or data acquisition frequency of the logging tool.
17. A method as defined in paragraphs 15 or 16, wherein the cost function considers at least one of a logging tool resolution; the speed; the data acquisition frequency; wireline tension force; or operation time.
18. A downhole logging system, comprising a tool string positioned along a wellbore, the tool string comprising one or more logging tools; and one or more sensors; and a logging operation controller comprising processing circuitry to implement any of the methods of paragraphs 1-17.

Although various embodiments and methodologies have been shown and described, the disclosure is not limited to such embodiments and methodologies and will be understood to include all modifications and variations as would be apparent to one skilled in the art. Therefore, it should be understood that embodiments of the disclosure are not intended to be limited to the particular forms disclosed. Rather, the intention is to cover all modifications, equivalents and alternatives falling within the spirit and scope of the disclosure as defined by the appended claims.

1. A method for optimizing a downhole logging operation, comprising:
deploying a logging tool into a wellbore extending along a formation;
acquiring logging data of the formation;
determining a desired logging resolution for the logging tool based upon the acquired logging data;
determining logging tool constraints necessary to achieve the desired logging resolution;
generating control commands for the logging tool based upon the logging tool constraints; and
operating the logging tool in accordance to the control commands.

2. A method as defined in claim 1, wherein determining the logging tool constraints comprises determining speed constraints of the logging tool.

3. A method as defined in claim 1, wherein determining the logging tool constraints comprises determining data acquisition frequency constraints of the logging tool.

4. A method as defined in claim 1, wherein determining the logging tool constraints comprises:
determining speed constraints of the logging tool;
determining data acquisition frequency constraints of the logging tool; and
comparing the speed and data acquisition frequency constraints using a cost function,
wherein the logging tool constraints are selected based upon the comparison.

5. A method as defined in claim 1, wherein acquiring the logging data of the formation comprises acquiring historical logging data of the wellbore.

6. A method as defined in claim 1, wherein acquiring the logging data of the formation comprises acquiring logging data of an adjacent wellbore.

7. A method as defined in claim 1, wherein acquiring the logging data of the formation comprises acquiring real-time logging data of the wellbore.

8. A method as defined in claim 1, wherein the logging data comprises acquiring motion data of the logging tool.

9. A method as defined in claim 1, wherein determining the desired logging resolution comprises:
generating a first spatial profile of a variable of interest along a distance of the wellbore near a current position of the logging tool, the first spatial profile comprising data related to a position of the logging tool with respect to a magnitude of the variable of interest;
selecting a subset of the data over the distance of the wellbore;
generating a second spatial profile for the variable of interest using the subset of data;
comparing the first and second spatial profiles; and
determining the desired logging tool resolution based upon the comparison.

10. A method as defined in claim 9, wherein the variable of interest is represented by a single data point or a plurality of data points.

11. A method as defined in claim 1, wherein determining the logging tool constraints comprises minimizing a cost function subject to the logging tool constraints.

12. A method as defined in claim 11, wherein the cost function penalizes a deviation of an actual logging resolution from the desired logging resolution.

13. A method as defined in claim 11, wherein the cost function considers logging tool constraints comprising at least one of a logging tool speed, wireline tension force or operation time.

14. A method as defined in claim 1, wherein the logging tool is deployed as part of a wireline, drilling or slick line assembly.

15. A method for optimizing a downhole logging operation, the method comprising:
deploying a logging tool into a wellbore extending along a formation;
acquiring logging data of the formation; and
adjusting in real-time at least one of a speed or data acquisition frequency of the logging tool based upon the acquired logging data.

16. A method as defined in claim 15, further comprising utilizing a cost function to determine whether to adjust the speed or data acquisition frequency of the logging tool.

17. A method as defined in claim 16, wherein the cost function considers at least one of:
a logging tool resolution;
the speed;
the data acquisition frequency;
wireline tension force; or
operation time.

18. A downhole logging system, comprising:
a tool string positioned along a wellbore, the tool string comprising:
one or more logging tools; and
one or more sensors; and
a logging operation controller comprising processing circuitry to implement the method of claim 1.
